(19) United States
(12) Patent Application Publication
(10) Pub. No.: US 2015/0356532 A1
(43) Pub. Date: Dec. 10, 2015

(54) VENDING MACHINE THAT TRANSMITS ELECTRONIC DATA OF A PRODUCT OR SERVICE PURCHASED THEREAT

(71) Applicant: Toshiba Tec Kabushiki Kaisha, Tokyo (JP)

(72) Inventor: Tsuyoshi GOTANDA, Ota Tokyo (JP)

(21) Appl. No.: 14/733,879

(22) Filed: Jun. 8, 2015

(30) Foreign Application Priority Data
Jun. 9, 2014 (JP) 2014-118885

(51) Int. Cl. G06Q 20/14; G07F 9/00; G06Q 30/06

(52) U.S. Cl. CPC G06Q 20/14; G06Q 30/0633; G07F 9/006

(57) ABSTRACT

A vending machine includes a first input device through which a user selects a product or service to be purchased, a second input device by which the user submits payment information to a first server, a dispensing unit configured to dispense a product or service that the user selects through the first input device upon receiving confirmation of payment from the first server, and a communication unit configured to transmit electronic data describing the product or service purchased and the payment information to a second server.

### CROSS-REFERENCE TO RELATED APPLICATION

This application is based upon and claims the benefit of priority from Japanese Patent Application No. 2014-118885, filed Jun. 9, 2014, the entire contents of which are incorporated herein by reference.

### FIELD

Embodiments described herein relate generally to a vending machine, particularly a vending machine that transmits electronic data of a product or service purchased thereat.

### BACKGROUND

Today, many vending machines are provided on a street or the like to sell products or provide services. Vending machines of one type accept payment by payment media other than cash, such as a credit card, an IC card, or an electronic money card.

Vending machines of another type issue paper receipts that describe details of purchase transactions carried out at the vending machines. Typically, such vending machines have a printer that prints paper receipts using sheets of paper. However, when the paper is used up as the paper receipts are issued, a maintenance person has to refill new sheets of paper. In addition, a mechanism to detect a remaining amount of the paper may be needed, so that the maintenance person can recognize the amount.

### DESCRIPTION OF THE DRAWINGS

FIG. 1 illustrates an entire structure of an electronic receipt system according to a first embodiment.

FIG. 2 is a block diagram of a POS terminal in the electronic receipt system.

FIG. 3 is a memory map of a RAM in a control unit of the POS terminal.

FIG. 4 is a block diagram of an electronic receipt server in the electronic receipt system.

FIG. 5 is a block diagram of an electronic receipt management server in the electronic receipt system.

FIGS. 6 and 7 each are a memory map of a storage unit in the electronic receipt management server.

FIG. 8 is a block diagram of a portable terminal in the electronic receipt system.

FIG. 9 is a block diagram of a vending machine in the electronic receipt system.

FIG. 10 is a block diagram of a settlement server in the electronic receipt system.

FIG. 11 is a flowchart illustrating a flow of control processing carried out by the POS terminal.

FIG. 12 is a flowchart illustrating a flow of control processing carried out by the electronic receipt server.

FIG. 13 illustrates functional blocks of a vending machine according to the first embodiment.

FIG. 14 is a flowchart illustrating a flow of control processing carried out by the vending machine according to the first embodiment.

FIG. 15 is a flowchart illustrating a flow of control processing carried out by the settlement server.

FIG. 16 illustrates functional blocks of the electronic receipt management server.

FIG. 17 is a flowchart illustrating a flow of control processing carried out by the electronic receipt management server.

FIG. 18 is a flowchart illustrating a flow of control processing carried out by the portable terminal.

FIG. 19 illustrates functional blocks of a vending machine according to a second embodiment.

FIG. 20 is a flowchart illustrating a flow of control processing carried out by the vending machine according to the second embodiment.

### DETAILED DESCRIPTION

An embodiment provides a vending machine which may provide information on a purchase transaction without issuing a paper receipt.

According to an embodiment, a vending machine includes a first input device through which a user selects a product or service to be purchased, a second input device by which the user submits payment information to a first server, a dispensing unit configured to dispense a product or service that the user selects through the first input device upon receiving confirmation of payment from the first server, and a communication unit configured to transmit electronic data describing the product or service purchased and the payment information to a second server.

According to another embodiment, a vending machine includes an input device through which a user selects a product or service to be purchased, a reading and writing device configured to read payment information and a balance from a payment medium carried by the user and write a value calculated by deducting a value of the product or service selected through the input device from the balance, in the payment medium, a dispensing unit configured to dispense a product or service that the user selects through the first input device upon confirmation of payment, and a communication unit configured to transmit electronic data describing the product or service purchased and the payment information to a server.

Hereinafter, embodiments will be described with reference to the accompanying drawings. These embodiments are described using a vending machine as an example of an automatic charge collection apparatus. An electronic receipt management server is described as an example of an information processing apparatus. This technology is not limited to the following described embodiments. For example, the automatic charge collection apparatus may be a ticket machine or an automatic ticket gate. Further, the information processing apparatus may be a settlement server.

### First Embodiment

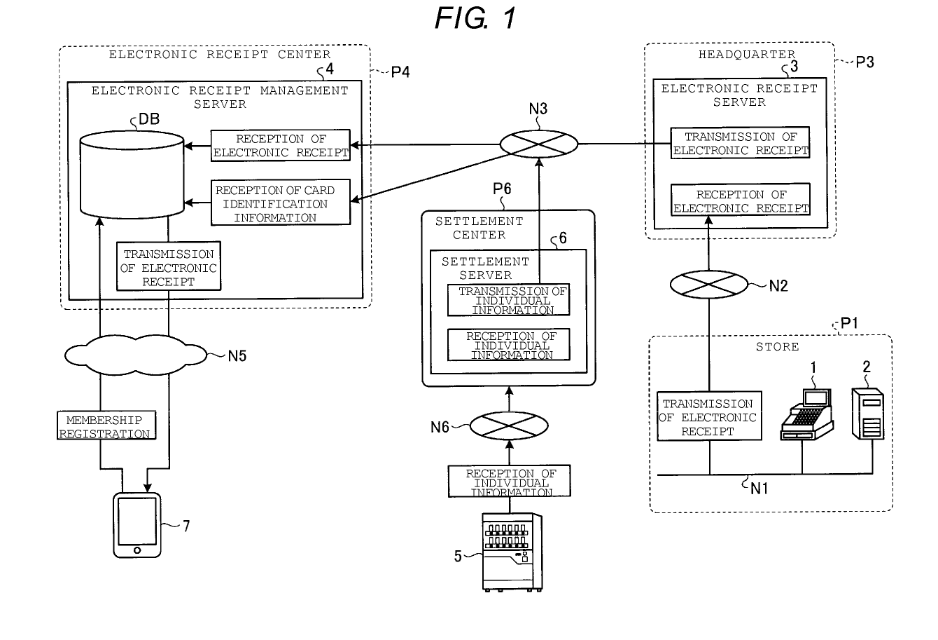

FIG. 1 illustrates an entire structure of an electronic receipt system according to a first embodiment. As illustrated in FIG. 1, the electronic receipt system includes a POS (Point of Sales) terminal 1, which is located in a store P1 such as a shopping center, a store server 2, an electronic receipt server 3, which is located in a headquarter P3, an electronic receipt management server 4, which is located in an electronic receipt center P4, a portable terminal 7 which is carried by a customer, a vending machine 5, and a settlement server 6 which is located in a settlement center P6.

The POS terminal 1 is connected to a network N2 which connects the store P1 and the headquarter P3. The network N2 is, for example, a dedicated line such as the Internet and a virtual private network (VPN).

The POS terminal 1 is a merchandise sales data processing apparatus and executes merchandise sales data processing in the store P1. The POS terminal 1 generates receipt information, which includes transaction details of purchased merchandise, and causes a printing unit 13 to print the receipt information, as a paper receipt. The POS terminal 1 generates digitalized electronic receipt information by converting a unstructured format of receipt information, which is a first data format, into a structured format, which is a second data format different from the unstructured format. The electronic receipt information is receipt information obtained by converting receipt information which is originally generated to be printed on a receipt sheet into the structured format such as a comma-separated values (CSV) type and a J-son type, for example. The electronic receipt information is transmitted to the electronic receipt management server 4 through the electronic receipt server 3 and the transmitted electronic receipt information is stored in the electronic receipt management server 4. The electronic receipt information stored in the electronic receipt management server 4 may be transmitted to the portable terminal 7 and be viewed thereon. The portable terminal 7 displays the electronic receipt information in substantially the same format as that of receipt information which is printed in a receipt sheet.

The POS terminal 1 outputs (transmits) the generated electronic receipt information to the electronic receipt server 3 through the network N2. A transmission method of the electronic receipt information is not particularly limited, and may use a general protocol such as HTTP and HTTPS. The number of POS terminals 1 in the store P1 is not particularly limited, and may be plural.

The store server 2 manages sales in store P1. The store server 2 is connected to the POS terminal 1 through a communication line N1 such as a local area network (LAN), which is provided in the store P1. The store server 2 manages sales information of the store P1 based on sales information in the POS terminal 1. The store server 2 collects pieces of sales information of each POS terminal in the store P1 as calculation receipt information. The calculation receipt information is information obtained by accumulating pieces of sales information which are generated by the store P1 during a predetermined period of time (for example, a day). The calculation receipt information is, for example, information obtained by accumulating pieces of sales information by section or class, by payment methods, by time zone, or by other criteria, in addition to all sales information during the predetermined period of time.

The electronic receipt server 3 is located in the headquarter P3 of a company which operates the store P1. The electronic receipt server 3 has a function as a receipt management server for the company, which manages receipt information associated with the company.

The electronic receipt server 3 receives electronic receipt information transmitted from the POS terminal 1, through the network N2. The electronic receipt server 3 transmits the received electronic receipt information to the electronic receipt management server 4 through a network N3, which connects the headquarter P3 and the electronic receipt center P4.

The network N3 is, for example, a dedicated line such as the Internet and a VPN. A transmission method of the electronic receipt information is not particularly limited, and a general protocol such as HTTP and HTTPS may be used.

The electronic receipt management server 4 is located in the electronic receipt center P4. The electronic receipt center P4 manages electronic receipt information and electronic calculation receipt information of multiple companies, each of which manages receipt information using. The electronic receipt management server 4 is, for example, a third party organization other than the company which manages the electronic receipt server 3. Alternatively, the electronic receipt server 3 may be managed by a third party organization and the like.

The electronic receipt management server 4 functions as a receipt management server of a customer, and collectively manages electronic receipt information of multiple companies each of which operate one or more stores. The electronic receipt management server 4 stores and manages membership data in a membership master which is contained in a database DB. The membership data includes a member ID, a terminal code (SRID), and transmission destination information of the portable terminal 7. The member ID is name or a customer code of each customer (member) who has completed membership registration. The terminal code is an example of reception destination information for specifying a reception destination (mobile terminal 7) of electronic receipt information. The transmission destination information of the portable terminal 7 indicates a transmission destination (e.g., mail address) of electronic receipt information. In the embodiment, the portable terminal 7 is set to be the reception destination. However, application software which is installed on the portable terminal 7 and operates to display electronic receipt information may be reception destination. A membership management server and the like, which stores and manages the membership data, may be provided separately from the electronic receipt management server 4.

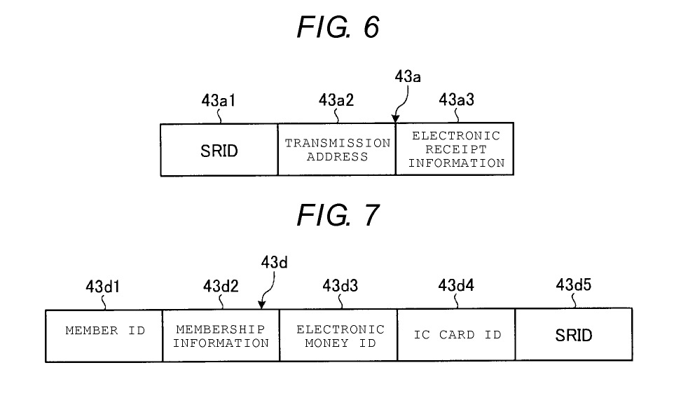

The electronic receipt management server 4 receives electronic receipt information which is transmitted from the electronic receipt server 3, through the network N3. The electronic receipt management server 4 stores and manages the received electronic receipt information in an electronic receipt information section 43a3 of an electronic receipt management region 43a, which is contained in the database DB (see FIG. 6). More specifically, the electronic receipt information includes transaction details (merchandise sales data) of a purchase transaction, store information of a store which transmits electronic receipt information, the member ID, and the like. The electronic receipt information is managed in correlation with membership data of the corresponding member.

When electronic receipt information is stored in the database DB, the electronic receipt management server 4 specifies a transmission destination (portable terminal 7) based on the member ID include in the electronic receipt information. The electronic receipt management server 4 transmits to a transmission destination a notification that electronic receipt information is ready to be transmitted, through a network N5.

If an electronic receipt inquiry including a designated member ID is received from the portable terminal 7, which is connected to the electronic receipt management server 4, through the network N5, the electronic receipt management server 4 extracts electronic receipt information corresponding to the member ID from the database DB, and transmits the extracted electronic receipt information to the portable terminal 7. When additional information is correlated with the electronic receipt information, the additional information is also transmitted to the portable terminal 7.

The portable terminal 7 is a terminal apparatus carried and used by a user (customer) of the electronic receipt system, such as a smart phone, a mobile phone, a personal digital assistant (PDA), and a tablet computer. The portable terminal 7 includes an application for displaying various kinds of information provided over the network N5, such as a web browser.

The portable terminal 7 performs membership registration to the electronic receipt system by accessing electronic receipt management server 4 through the network N5. The network N5 is, for example, the Internet or various public networks.

In the electronic receipt system, membership registration of a customer that enables the portable terminal 7 to receive electronic receipt information is performed through the following procedures, for example. A customer transmits a blank mail from the portable terminal 7 to the electronic receipt management server 4 through the network N5. The electronic receipt management server 4 transmits a Uniform Resource Locator (URL) of a webpage for membership registration to a mail address specified in the received mail. The customer accesses the webpage for membership registration through the portable terminal 7 and causes an input screen to be displayed. The input screen is for inputting information (name, transmission destination information, and the like) necessary for membership registration. After the customer completes the inputs, the electronic receipt management server 4 performs membership registration on the membership master. Then, the electronic receipt management server 4 delivers a membership registration completion mail including a member ID and a password to the portable terminal 7. In such a manner, the membership registration can be performed.

The portable terminal 7 receives a notification indicating that the electronic receipt management server 4 is ready to transmit electronic receipt information after a purchase transaction has been performed at the POS terminal 1. A member may operate the portable terminal 7 to transmit a request for electronic receipt information to the electronic receipt management server 4 through the network N5, so as to receive the electronic receipt information (and additional information of the member) from the electronic receipt management server 4. The portable terminal 7 displays the received electronic receipt information and additional information.

The vending machine 5 is located at many locations such as train or bus stations, commercial facilities, tourist facilities, and roadsides, regardless of the indoor and the outdoors. The vending machine 5 sells a large variety of merchandise, for example, beverages, foods, cigarettes, books, music, and information, and the like. For example, in a case of beverages or foods, the vending machine 5 stores merchandise, keeping the merchandise cool or warm. A customer purchases merchandise at the vending machine 5 using cash or a medium. The customer designates merchandise by operating a button, which is provided on the vending machine 5 and correspond to a merchandise model exhibited in the vending machine 5 or a merchandise image displayed on the vending machine 5. If the button is operated, the vending machine 5 discharges the designated merchandise to an output port

The vending machine 5 is connected to the settlement server 6, which is installed in the settlement center P6, through a network N6. The network N6 is a dedicated line such as the Internet and a VPN. A transmission method of the electronic receipt information is not particularly limited, and a general protocol such as HTTP and HTTPS may be used.

When purchasing merchandise with cash, a customer inserts cash and operates a button or the like of the vending machine 5. When purchasing merchandise using a monetary value which is stored in an electronic money card or an IC card (collectively, referred to as “card” below), a customer designates goods by operating a button, and brings the card near a card reader unit which includes a near field wireless communication unit or swipe the card through a card reader. Then, merchandise which is stored in the vending machine 5 is discharged. At this time, a monetary value, which is filled (refilled) in the card may be used, if the card is a prepaid type. In such a case, a monetary value that is equal to a price of the merchandise may be subtracted from the balance of the card.

Card identification information is stored in a card. The card identification information is an example of withdrawal destination information for specifying a withdrawal target of the monetary value. When merchandise is purchased by using the card, the vending machine 5 may specify the card identification information of the card by reading the card. In the embodiment, if the card identification information is identified, a user of the card may be also identified. However, the user may not be identified.

Merchandise may be also purchased with cash, while information is read from a card. In this case, cash is inserted, a card is held near the card reader, and then merchandise to be purchased is selected. In this manner, merchandise may be purchased with cash, and the card identification information of the card used in the purchase transaction may be specified. In this case, a monetary value of the card is not used.

The settlement server 6 is located in the settlement center P6, which is operated by a company that owns the vending machine 5, and functions as a server for the company. Specifically, the settlement center P6 collects and manages sales information of the vending machine 5. The settlement server 6 manages sales information which is collected from each vending machine 5, for example. For example, the settlement server 6 manages sales information by merchandise or by category of merchandise.

The settlement server 6 receives sales information which is transmitted from the vending machine 5, through the network N6. The settlement server 6 transmits card identification information which is received form the vending machine 5, and commercial information to the electronic receipt management server 4 through the network N3. The card identification information and the commercial information will be described below in detail. The settlement center P6 may be a third party organization which owns the vending machine 5, and operated jointly by a plurality of manufacturers.

In the electronic receipt system having the above configuration, merchandise sales data processing is performed by the POS terminal 1 of the store P1, and electronic receipt information indicating details of a purchase transaction (settlement) which is generated through the merchandise sales data processing is transmitted to the electronic receipt management server 4 through the electronic receipt server 3. Then, the electronic receipt information is uploaded to the web. After the portable terminal 7 that has an installed web browser designates a Uniform Resource Locator (URL), the portable terminal 7 may download the electronic receipt information uploaded to the web to the portable terminal 7 and display the downloaded receipt information with the web browser. An application different from the web browser, may be installed on the portable terminal 7 to display the electronic receipt.

Merchandise information (commercial information) of merchandise which has been sold by the vending machine 5 is transmitted from the vending machine 5 to the electronic receipt management server 4 through the settlement server 6. The electronic receipt management server 4 receives the merchandise information which is transmitted from the vending machine 5, and generates electronic receipt information. After the portable terminal 7 having an installed web browser designates a Uniform Resource Locator (URL), the portable terminal 7 may download the electronic receipt information uploaded to the web to the portable terminal 7 and display the downloaded receipt information with the web browser.

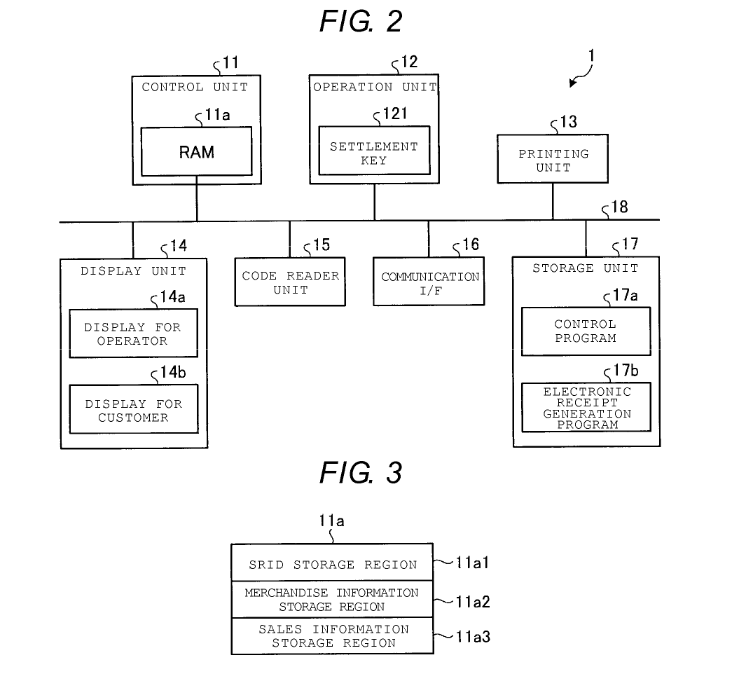

Next, hardware configurations of main apparatuses of the electronic receipt system according to the present embodiment will be described with reference to FIGS. 2 to 10.

First, the POS terminal 1 will be described. FIG. 2 is a block diagram of the POS terminal 1. As illustrated in FIG. 2, the POS terminal 1 includes a control unit 11 which generally controls various computations or each unit of the POS terminal 1. The control unit 11 includes a central processing unit (CPU), a read only memory (ROM), a random access memory (RAM) 11a, a real time clock (RTC) unit, and the like. The ROM stores various programs or data. The RAM 11a stores temporarily various programs and stores various data so as to be rewritable. The RTC unit indicates the current date and time.

The control unit 11 is connected to an operation unit 12, a printing unit 13, a display unit 14, a code reader unit 15, a communication I/F 16, and a storage unit 17 through a bus 18.

The operation unit 12 has various operation keys in order for an operator to perform input operations. The operation keys include a numeric key for inputting a numerical value, a cursor key, a selection and determination key for selecting a predetermined item, a settlement key 121, and the like. The settlement key 121 triggers settlement processing of one transaction and ends the transaction.

The printing unit 13 is configured as a printer device for printing a receipt, a journal, a calculation receipt, a test receipt, and the like. The printing unit 13 prints information such as merchandise information of purchased merchandise, settlement information obtained through the settlement processing, calculation information, and test information on a roll sheet which is transferred by a thermal head having a heat medium, for example. Then, the printing unit 13 issues the receipt, the journal, the calculation receipt, the test receipt, and the like by cutting the sheet out.

The display unit 14 is a liquid crystal display, for example. The display unit 14 displays various kinds of information including name and a price of merchandise registered for sales, a total price, and an amount of change in one transaction in which settlement is declared, and the like. The display unit 14 also displays various kinds of information related to issue processing of a calculation receipt, generation processing and transmission processing of electronic calculation receipt information, and issue processing of a test receipt. The display unit 14 includes a display 14a for an operator, which displays various kinds of information to a cashier and a display 14b for a customer, which displays various kinds of information to a customer. The display unit 14 may have a configuration of a touch panel. In this case, the touch panel functions as the operation unit 12.

The code reader unit 15 is a scanner device that optically reads a code symbol such as a bar code and a two-dimensional code, for example. The code reader unit 15 reads, for example, a code symbol printed on merchandise or a code symbol displayed on a display unit of the portable terminal 7, and the like. The control unit 11 recognizes information contained in the read code symbol. The code symbol printed on the merchandise contains a merchandise code and the like for specifying the merchandise. The code symbol displayed in the portable terminal 7 contains an SRID, a member ID, or the like for specifying a customer who carries the portable terminal 7. The SRID or the member ID may be stored magnetically or electrically in the portable terminal 7. In this case, a dedicated reading apparatus reads the stored SRID or member ID, and the control unit 11 recognizes the read SRID or member ID.

The control unit 11 is connected to the communication I/F (interface) 16 through the bus 18, and is configured to be connected to the network N2 through the communication I/F 16.

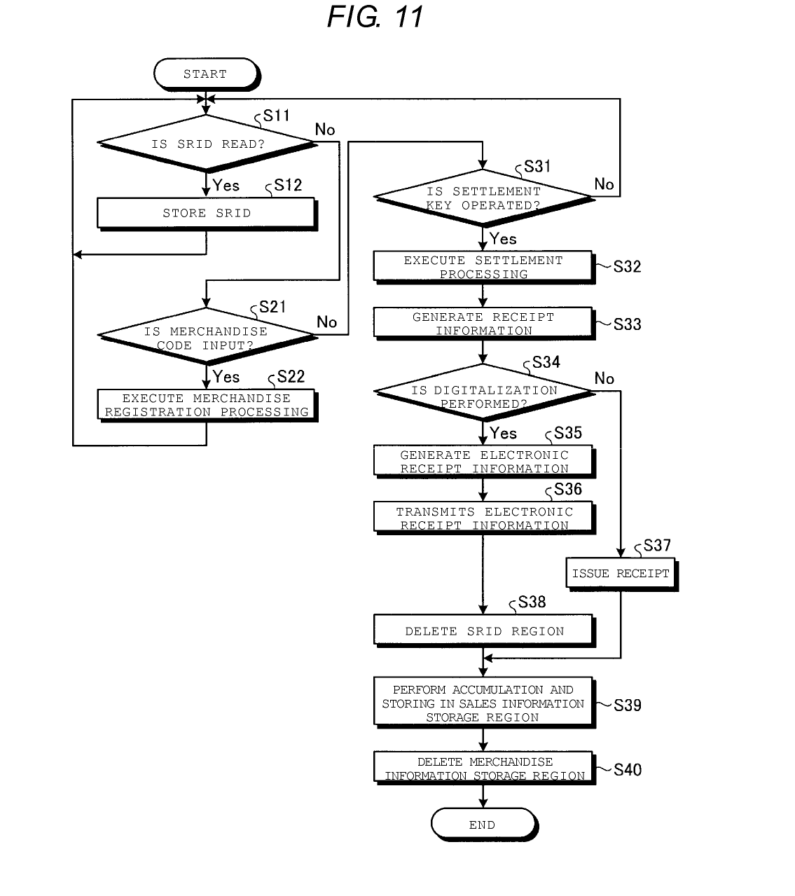

The control unit 11 is connected to the storage unit 17 through the bus 18. The storage unit 17 is an auxiliary storage device such as a hard disk drive (HDD) and a solid state drive (SSD), for example. The storage unit 17 stores a control program 17a for performing various POS operations including the merchandise sales data processing, calculation processing, and test processing. The control unit 11 performs the merchandise sales data processing or processing relating to receipt information, by executing the control program 17a (see FIG. 11). The storage unit 17 also stores various data files relating to the merchandise sales data processing, such as a merchandise data file (not shown in FIG. 2). The merchandise data file contains merchandise data of a merchandise name, a merchandise code, a unit price, and the like of the merchandise. The control unit 11 performs the calculation processing and the test processing, by executing the control program. 17a (see FIG. 11).

The storage unit 17 also stores an electronic receipt generation program 17b for generating electronic receipt information from receipt information. By executing the electronic receipt generation program 17b, the control unit 11 converts receipt information of the unstructured format into electronic receipt information of the structured format, in accordance with on a conversion rule described in a receipt information schema (not illustrated). In this manner, the control unit 11 generates electronic receipt information from receipt information (see FIG. 11).

The electronic receipt information generated by the POS terminal 1 includes a member ID, a company code (identification code of a company which operates a store), a store code, a POS number of the POS terminal 1, a receipt number, merchandise sales data (including date and time data), and the like. A manufacturer of consumer goods, and the like may obtain a proof of a purchase transaction of merchandise associated with the manufacturer, using the electronic receipt information, in accordance with a specific condition (for example, a specific company which operates a store, a specific geographic region, a specific time, and the like). The electronic receipt information generated by the POS terminal 1 also includes an SRID for specifying the portable terminal 7 to which the electronic receipt information is to be transmitted.

The storage unit 17 stores a POS number for identifying the own POS terminal 1, a company code (identification code of a company which operates a store), a business type and business category code, a store code of the store P1, and the like. The business type and business category code is, for example, a code (classification code) for identifying a business type and a business category of the store, such as a convenience store, a supermarket, a department store, a pharmacy, a restaurant, an eatery, and the like. A different store code is assigned to different stores operated by a same company. The business type and business category may be arbitrarily changed in accordance with preference of a user. The company code and the business type and business category code may be registered in the electronic receipt server 3.

Next, a portion of a memory map of the RAM 11a in the control unit 11 of the POS terminal 1 will be described. In FIG. 3, the RAM 11a includes a SRID storage region 11a1, a merchandise information storage region 11a2, and a sales information storage region 11a3.

The SRID storage region 11a1 stores an SRID or a member ID, which are input from the code reader unit 15. The merchandise information storage region 11a2 stores merchandise information (merchandise code, merchandise name, unit price, attribute information, and the like) read from a merchandise master (not illustrated), corresponding to a merchandise code input from the code reader unit 15. The sales information storage region 11a3 stores sales information, which is accumulation information of merchandise information, settlement information, and the like of merchandise for which the settlement processing has been performed. The sales information storage region 11a3 stores the sales information accumulated for a predetermined period of time until the calculation processing by the POS terminal 1 is initiated.

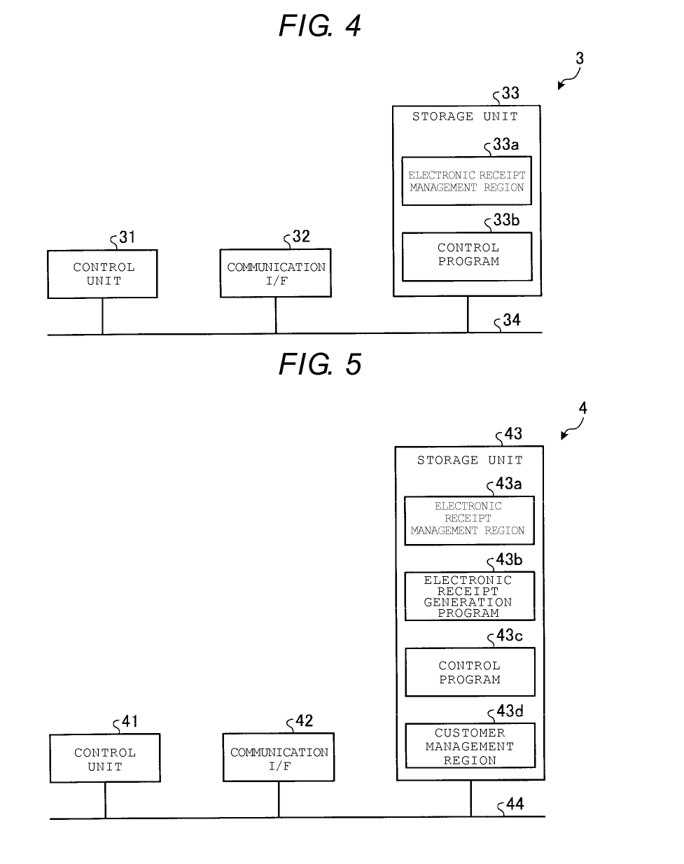

Next, a hardware configuration of the electronic receipt server 3, functioning as the receipt management server for a company, will be described using a block diagram of FIG. 4. In FIG. 4, the electronic receipt server 3 includes a control unit 31 which generally controls various computations or each unit of the electronic receipt server 3. The control unit 31 includes a CPU, a ROM, a RAM, a RTC unit, and the like. The ROM stores various programs or data. The RAM temporarily stores various programs and stores various data so as to be rewritable. The RTC unit indicates the current date and time.

The control unit 31 is configured to be connected to the network N2 or the network N3 through a communication I/F 32 which is connected to a bus 34. The control unit 31 is connected to a storage unit 33 through the bus 34.

The storage unit 33 stores electronic receipt information of a company which operates one or more stores, in an electronic receipt management area 33a. The electronic receipt information includes a company code (identification code of a company which operates the stores), a business type and business category code, the store code, member IDs of shoppers, one or more POS numbers of the POS terminals 1, receipt numbers, merchandise sales data, and the like. The storage unit 33 stores a control program 33b for managing the electronic receipt information stored in the electronic receipt management area 33a.

Next, a hardware configuration of the electronic receipt management server 4, functioning as the receipt management server for a customer, will be described using a block diagram of FIG. 5. In FIG. 5, the electronic receipt management server 4 includes a control unit 41 which generally controls various computations or each unit of the electronic receipt management server 4. The control unit 41 includes a CPU, a ROM, a RAM, a RTC unit, and the like. The ROM stores various programs or data. The RAM temporarily stores various programs and stores various data so as to be rewritable. The RTC unit indicates the current date and time.

The control unit 41 is configured to be connected to the network N3 and the network N5 through a communication I/F 42 which is connected to a bus 44. The control unit 41 is connected to a storage unit 43 through the bus 44.

The storage unit 43 includes electronic receipt management region 43a, an electronic receipt generation program 43b, a control program 43c, and a customer management region 43d. The electronic receipt information is received from the electronic receipt server 3, and in the electronic receipt management region 43a, electronic receipt information of multiple companies, each of which operate one or more stores, is stored with respect to each member (customer), and the electronic receipt information. When the electronic receipt generation program 43b is executed, electronic receipt information is generated based on the merchandise information which is received from the settlement server 6. The electronic receipt information includes card identification information for specifying a card which is used when a customer purchases merchandise through the vending machine 5.

The electronic receipt information which is generated by the electronic receipt management server 4 based on merchandise information received from the vending machine 5 includes card identification information, a company code, a machine number of the vending machine 5, installation location of the vending machine 5, a receipt number, merchandise information (including date and time data), and the like. When a SRID is transmitted from the vending machine 5, the electronic receipt information generated by the electronic receipt management server 4 includes the SRID for specifying the portable terminal 7 to which the electronic receipt information is to be transmitted.

The storage unit 43 also stores the control program 43c for managing the electronic receipt management region 43a and the like. The storage unit 43 includes the customer management region 43d for managing data of customers who carry the portable terminals 7. Specifically, the customer management region 43d contains customer information, and a terminal code (SRID) for specifying the portable terminal 7 which is carried by the customer, with respect to each customer ID. The customer ID and the SRID are correlated with each other and then stored.

Next, the electronic receipt management region 43a will be described with reference to FIG. 6. In FIG. 6, electronic receipt information generated in a purchase transaction is stored in the electronic receipt management region 43a, for each purchase transaction. The electronic receipt management region 43a includes a SRID section 43a1, a transmission address section 43a2, and an electronic receipt information section 43a4. The SRID section 43a1 stores an electronic receipt ID (SRID) which is a terminal code of a portable terminal 7 to which an electronic receipt is to be transmitted. The SRID section 43a1 stores an SRID read by the code reader unit 15 of the POS terminal 1, an SRID received from the vending machine 5, or an SRID extracted based on the card identification information received from the vending machine 5. The transmission address section 43a2 stores transmission destination address associated with the portable terminal 7 to which electronic receipt information is to be transmitted. The electronic receipt information section 43a3 stores electronic receipt information with respect to each purchase transaction, which is generated by converting receipt information of the transaction in a structured form. In the embodiment, the electronic receipt information includes an SRID stored in the SRID section 43a1, transmission destination address stored in the transmission address section 43a2, electronic receipt information stored in the electronic receipt information section 43a3.

Next, the customer management region 43d will be described with reference to FIG. 7. The customer management region 43d stores an electronic money card ID (individual identification information), which is card identification information, an IC card ID (individual identification information), which is card identification information, an SRID (terminal identification information), or the like in correlation with a member ID (individual identification information) for identifying a customer. In FIG. 7, the customer management region 43d includes a member ID section 43d1, a membership information section 43d2, an electronic money ID section 43d3, an IC card ID section 43d4, and an SRID section 43d5.

The member ID section 43d1 stores ID of a specific member to whom an electronic receipt is to be transmitted, and the like. The membership information section 43d2 stores membership information (name, an address, a telephone number, a family structure, taste, a purchase history, an address of the portable terminal 7, and the like) of a member corresponding to the member ID. The electronic money ID section 43d3 stores an electronic money card ID of an electronic money card which is owned by a member, in correlation with the member ID. The IC card ID section 43d4 stores an IC card ID of an IC card owned by the member, in correlation with the member ID. The SRID section 43d5 stores an SRID of the portable terminal 7 carried by the member, in correlation with the member ID. That is, the customer management region 43d stores the member ID, the electronic money card ID, the IC card ID, and the SRID which are correlated with each other. Accordingly, it is possible to extract an SRID corresponding to a specific electronic money card ID or a specific IC card ID.

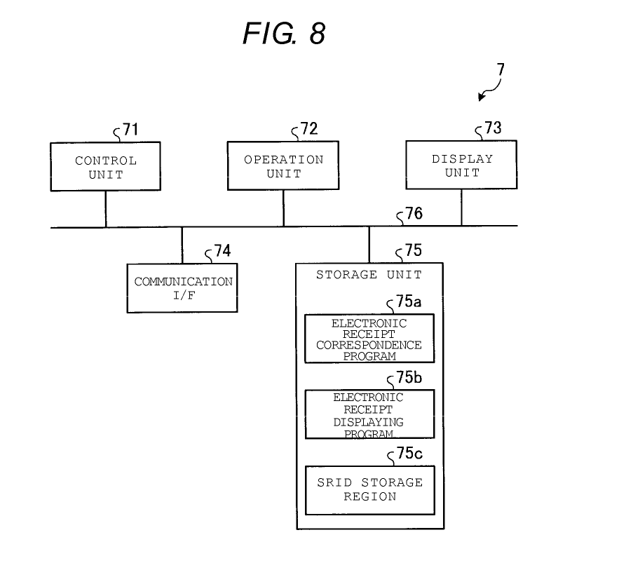

Next, a hardware configuration of the portable terminal 7 will be described using a block diagram of FIG. 8. In FIG. 8, the portable terminal 7 includes a control unit 71 which generally controls various computations or each unit of the portable terminal 7. The control unit 71 includes a CPU, a ROM, a RAM, a RTC unit, and the like. The ROM stores various programs or data. The RAM temporarily stores various programs and stores various data so as to be rewritable. The RTC unit indicates the current date and time.

An operation unit 72 is connected to a display unit 73 through a bus 76. The operation unit 72 has various operation keys or a pointing device for an operator (customer) performing input operations. The display unit 73 is a liquid crystal display, for example. The display unit 73 displays various kinds of information including electronic receipt information. The display unit 73 may have a touch panel. In this case, the touch panel functions as the operation unit 72.

The control unit 71 is connected to a communication I/F 74 through a bus 76. The control unit 71 is configured to be connected to the network N5 through the communication I/F 74.

The control unit 71 is connected to a storage unit 75 through a bus 76. The storage unit 75 includes an electronic receipt correspondence program 75a, an electronic receipt displaying program 75b, and an SRID storage region 75c, in addition to a web browser. The web browser is used to display various kinds of information (contents) uploaded to the web. The electronic receipt correspondence program 75a is executed to receive electronic receipt information from the electronic receipt management server 4. The electronic receipt displaying program 75b is executed to display the received receipt information. The SRID storage region 75c stores an SRID of the portable terminal 7 to which the electronic receipt information is to be transmitted. The SRID stored in the SRID storage region 75c is displayed on a display unit 73 by a code symbol. The POS terminal 1 scans a code symbol displayed on the display unit 73 using the code reader unit 15, and recognizes the SRID.

Alternatively, the SRID may be read magnetically or electrically by the POS terminal 1. The SRID may be read from a membership card or the like, instead of the portable terminal 7. A customer ID of a customer, instead of the SRID, may be read. In this case, the SRID stored in the corresponding electronic receipt management server 4 is obtained based on the read customer ID.

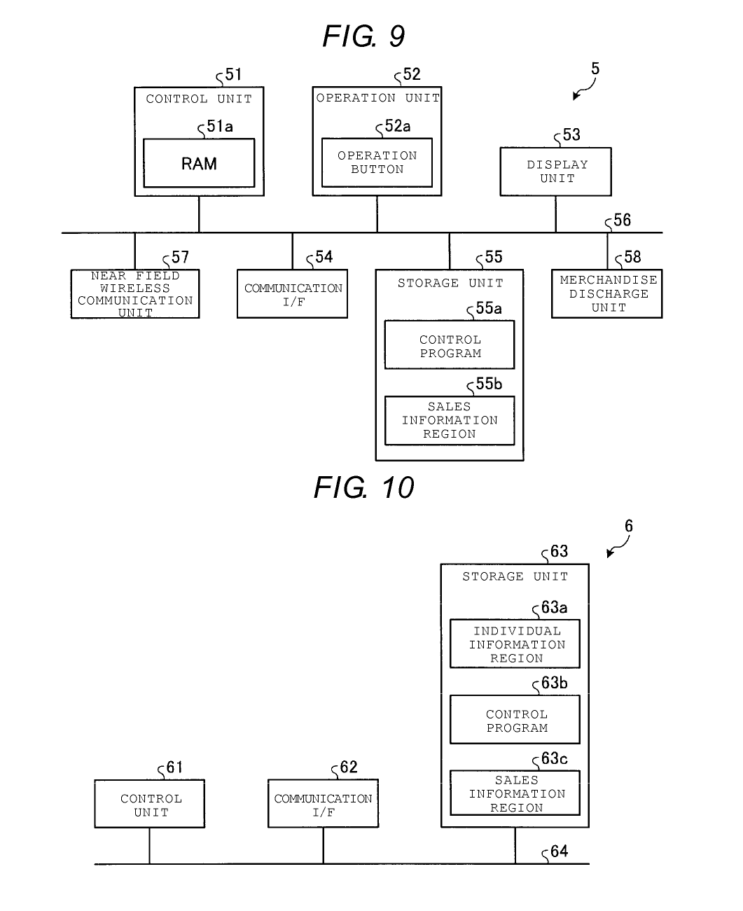

Next, a hardware configuration of the vending machine 5 will be described using a block diagram of FIG. 9. In FIG. 9, the vending machine 5 includes a control unit 51 which generally controls various computations or each unit of the vending machine 5. The control unit 51 includes a CPU, a ROM, a RAM 51a, a RTC unit, and the like. The ROM stores various programs or data. The RAM 51a temporarily stores various programs and stores various data so as to be rewritable. The RTC unit indicates the current date and time.

An operation unit 52 is connected to a display unit 53 through a bus 56. The operation unit 52 has various operation keys or a pointing device for an operator (customer) performing input operations. The operation unit 52 includes one or more operation buttons 52a. Each of the operation buttons 52a corresponds to one of merchandise sold through the vending machine 5. To designate merchandise to be purchased, a customer operates one of the operation buttons 52a.

The display unit 53 is a liquid crystal display, for example. The display unit 53 displays merchandise sold by the vending machine 5. The display unit 53 may have a touch panel. In this case, the touch panel functions as the operation buttons 52a of the operation unit 52.

The control unit 51 is connected to a communication I/F 54 through a bus 56. The control unit 51 is configured to be connected to the network N6 through the communication I/F 54.

The control unit 51 is connected to a storage unit 55 through the bus 56. The storage unit 55 includes a control program 55a for controlling an operation of the vending machine 5, and a sales information region 55b for storing sales information of merchandise sold through the vending machine 5.

The control unit 51 is connected to a near field wireless communication unit 57 through the bus 56. The near field wireless communication unit 57 includes a card reader unit. The near field wireless communication unit 57 establishes communication with a card which is held near the card reader unit (for example, becomes close to the card reader unit at a distance less than five centimeters), and reads card identification information from the card. The near field wireless communication unit 57 also reads a balance remaining in the card, or refills the card.

The control unit 51 is connected to a merchandise discharge unit 58 through the bus 56. If merchandise is selected, the control unit 51 transmits an instruction of discharging the designated merchandise, to the merchandise discharge unit 58. When the instruction to discharge the merchandise is received from the control unit 51, the merchandise discharge unit 58 discharges the merchandise to the output port, such that the customer may take the discharged merchandise out.

Next, a hardware configuration of the settlement server 6 will be described using a block diagram of FIG. 10. In FIG. 10, the settlement server 6 includes a control unit 61 which generally controls various computations or each unit of the settlement server 6. The control unit 61 includes a CPU, a ROM, a RAM, a RTC unit, and the like. The ROM stores various programs or data. The RAM temporarily stores various programs and stores various data so as to be rewritable. The RTC unit indicates the current date and time.

The control unit 61 is configured to be connected to the network N3 through a communication I/F 62, which is connected to a bus 64. The control unit 61 is connected to a storage unit 63 through the bus 64.

The storage unit 63 includes an individual information region 63a and a sales information region 63c, and stores a control program 63b. The individual information region 63a stores card identification information received from the vending machine 5, and an SRID. The sales information region 63c stores sales information of merchandise sold through the vending machine 5, which is received from the vending machine 5. The control program 63b performs various controls of the settlement server 6, which includes reading from or writing in the individual information region 63a or the sales information region 63c.

Next, control processing executed by each unit in the present embodiment will be described with reference to FIGS. 11 to 20.

First, control processing carried out by the control unit 11 of the POS terminal 1 when the control unit 11 executes the control program 17a and the electronic receipt generation program 17b will be described with reference to a flowchart illustrated in FIG. 11.

In FIG. 11, the control unit 11 of the POS terminal 1 determines whether or not an SRID stored in the portable terminal 7 is read by the code reader unit 15 (Step S11). When it is determined that the SRID is read (Yes in Step S11), the control unit 11 stores the read SRID in the SRID storage region 11a1 contained in the RAM 11a of the control unit 11 (Step S12). Then, the process returns to Step S11 and the control unit 11 goes into a standby state.

When it is determined that the SRID stored in the portable terminal 7 is not read (No in Step S11), the control unit 11 determines whether or not a code symbol attached to merchandise is read by the code reader unit 15 and a merchandise code is input (Step S21). When it is determined that the merchandise code is input (Yes in Step S21), the control unit 11 executes merchandise registration processing based on the input merchandise code (Step S22). Then, the process returns to Step S11 and the control unit 11 goes into a standby state.

In the merchandise registration processing, merchandise master (not illustrated) stored in the storage unit 17 is searched, and merchandise information (merchandise code, merchandise name, unit price, attribute information, and the like) stored in the merchandise master corresponding to the input merchandise code are read and stored in the merchandise information storage region 11a2 contained in the RAM 11a.

When it is determined that the merchandise code is not input (No in Step S21), the control unit 11 determines whether or not the settlement key 121 is operated (Step S31). When it is determined that the settlement key 121 is operated (Yes in Step S31), the control unit 11 executes the payment processing of the transaction (Step S32). The payment processing is processing of calculating a total price based on merchandise information stored in a merchandise information region, displaying the calculated total price on the display unit 14, and ending the transaction upon payment by various payment methods. The control unit 11 generates receipt information in the unstructured format based on payment information of the transaction (Step S33). When the SRID is stored in the SRID storage region 75c, receipt information in the unstructured format, including the SRID are generated in Step S33.

The control unit 11 determines whether or not electronic receipt information is to be generated, based on the receipt information (Step S34). When the SRID is included in the generated receipt information, the control unit 11 determines that the electronic receipt information is to be generated.

When it is determined that the electronic receipt information is to be generated (Yes in Step S34), the control unit 11 executes the electronic receipt generation program 17b to convert the receipt information generated in Step S33, which is in the unstructured format, to electronic receipt information in the structured format (Step S35). The generated electronic receipt information includes the SRID, and the store code of the store P1 in which the POS terminal 1 is located, as illustrated in FIG. 6. The control unit 11 transmits the generated electronic receipt information including the SRID and the store code to the electronic receipt server 3 (Step S36).

The control unit 11 deletes the SRID stored in the SRID storage region 11a1 (Step S38). The control unit 11 accumulates and stores merchandise information stored in the merchandise information storage region 11a2, in the sales information storage region 11a3 (Step S39). Then, the control unit 11 deletes the merchandise information stored in the merchandise information storage region 11a2 (Step S40). Thereafter, the control unit 11 ends processing. In Step S34, when it is determined that the electronic receipt information is not to be generated (No in Step S34), the control unit 11 controls the printing unit 13 to print the receipt information generated in Step S33, on a long paper receipt sheet, as a paper receipt (Step S37).

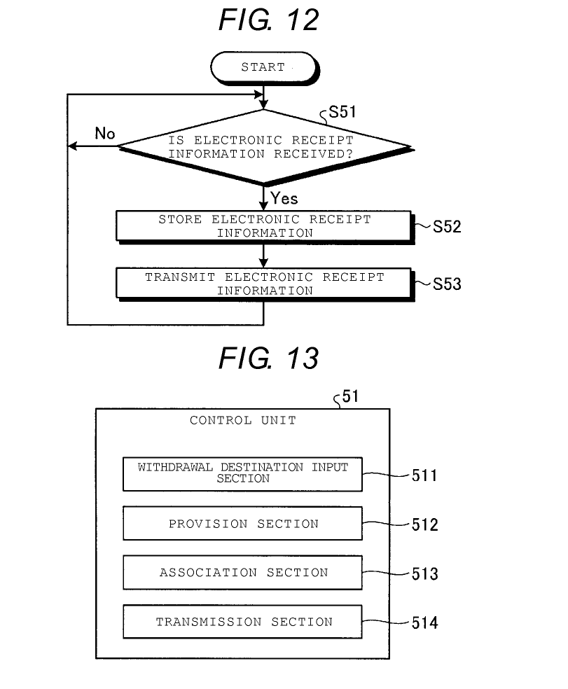

Next, a flow of electronic receipt management processing carried out by the control unit 31 of the electronic receipt server 3 when the control unit 31 executes the control program 33b will be described with reference to a flowchart illustrated in FIG. 12.

The control unit 31 of the electronic receipt server 3 determines whether or not the electronic receipt information transmitted from the POS terminal 1 in Step S36 is received through the communication I/F 32 (Step S51). When it is determined that the electronic receipt information is received (Yes in Step S51), the control unit 31 stores the received electronic receipt information in the electronic receipt management area 33a of the storage unit 33 as electronic receipt information of a corresponding company (Step S52). The control unit 31 transmits the electronic receipt information stored in Step S52 to the electronic receipt management server 4 (Step S53), and the process returns to Step S51.

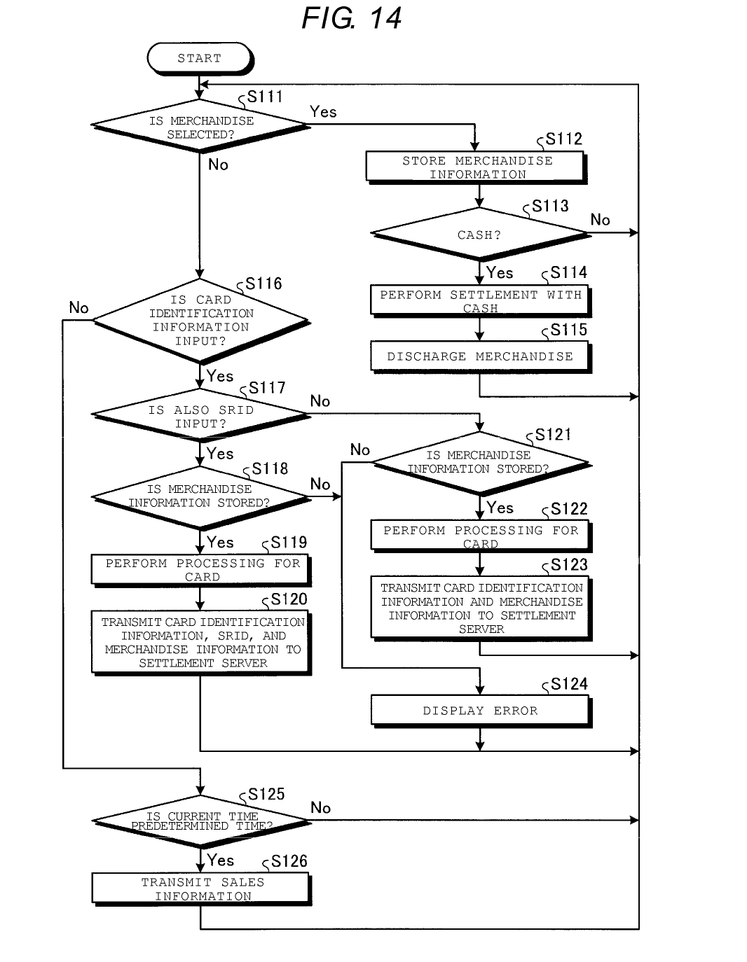

Next, control processing carried out by the control unit 51 of the vending machine 5 when the control unit 5 executes the control program 55a will be described with reference to a functional block diagram illustrated in FIG. 13 and a flowchart illustrated in FIG. 14.

As illustrated in FIG. 13, when the control program 55a is executed by the vending machine 5, modules including a withdrawal destination input section 511, a provision section 512, an association section 513, and a transmission section 514 are generated. As actual hardware, the CPU of the control unit 51 reads the control program 55a from the storage unit 55 and executes the read control program 55a. As a result, the withdrawal destination input section 511, the provision section 512, the association section 513, and the transmission section 514 are generated.

The withdrawal destination input section 511 has a function to input withdrawal destination information for specifying a withdrawal destination of a monetary value from a storage medium.

The provision section 512 has a function to provide merchandise or a service to a customer in accordance with an operation.

The association section 513 has a function to associate the input withdrawal destination information and commercial information including information on the provided merchandise or service.

The transmission section 514 has a function to transmit the withdrawal destination information and the commercial information, which are associated with each other, to an external apparatus which stores reception destination information for specifying a reception destination of electronic receipt information obtained by digitalizing the commercial information.

FIG. 14 is a flowchart illustrating control processing of the vending machine 5. In FIG. 14, the control unit 51 determines whether or not the operation button 52a of the operation unit 52 is operated and thus merchandise is selected (Step S111). When it is determined that the merchandise is selected (Yes in Step S111), the control unit 51 stores merchandise information of the selected merchandise in the RAM 51a (Step S112). The control unit 51 determines whether or not cash sufficient to purchase the selected merchandise has been already inserted into the vending machine 5 (Step S113).

When it is determined that sufficient cash is inserted (Yes in Step S113), the control unit 51 executes the settlement processing based on the inserted cash (Step S114). That is, the control unit 51 calculates change obtained from an amount of the inserted cash and a charged amount, and discharge the change, if any. The control unit 51 stores information of the purchased merchandise and settlement information obtained by performing settlement (collectively “merchandise information”) in the sales information region 55b. The control unit 51 controls the merchandise discharge unit 58 to discharge the purchased merchandise to the output port (Step S115). Then, the process returns to Step S111 and the control unit 51 goes into a standby state. In Step S113, when it is determined that the sufficient cash is not inserted (No in Step S113), the process returns to Step S111 and the control unit 51 goes into a standby state.

In Step S111, when it is determined that the merchandise is not selected (No in Step S111), the control unit 51 determines whether or not card identification information, which is the individual identification information, is read from a card through the near field wireless communication unit (Step S116). When it is determined that the card identification information is read (Yes in Step S116), the control unit 51 sequentially determines whether or not an SRID is also read through the near field wireless communication unit 57 (Step S117). The SRID may be stored in an electronic money card, an IC card, the portable terminal 7, or the like, and read therefrom.

When it is determined that the SRID is read (Yes in Step S117), the control unit 51 determines whether or not the merchandise information is stored in the RAM 51a (Step S118). When it is determined that the merchandise information is stored (Yes in Step S118), which means that the merchandise is selected, the control unit 51 executes the settlement processing for the selected merchandise with the card, based on a balance remaining in the card (Step S119). That is, the control unit 51 reads the balance from the card, subtracts a monetary value corresponding to a price of the purchased merchandise from the balance, and then writes the balance after subtraction to the card. At this time, the control unit 51 stores the merchandise information of the sold merchandise in the sales information region 55b. Then, the control unit 51 transmits the card identification information, the SRID, and the merchandise information obtained through the settlement processing, to the settlement server 6 (Step S120). Then, the process returns to Step S111 and the control unit 51 goes into a standby state. The card identification information, the SRID, and the merchandise information obtained through the settlement processing, which are transmitted in Step S120, are in an unstructured format.

In Step S117, when it is determined that the SRID is not input (No in Step S117), the control unit 51 determines whether or not the merchandise information is stored in the RAM 51a (Step S121). When it is determined that the merchandise information is stored (Yes in Step S121), which means that the merchandise is selected, the control unit 51 executes the settlement processing for the merchandise with a card, using a balance of the card (Step S122). That is, the control unit 51 reads the balance from the card, subtracts a monetary value corresponding to a price of the purchased merchandise from the balance, and then writes a balance after the subtraction in the card. At this time, the control unit 51 stores the merchandise information of the sold merchandise in the sales information region 55b. The control unit 51 transmits the input card identification information and the merchandise information obtained through the settlement processing, to the settlement server 6 (Step S123). Then, the process returns to Step S111 and the control unit 51 goes into a standby state. The card identification information and the merchandise information obtained through the settlement processing, which are transmitted in Step S123, are in an unstructured format.

In Step S118 or S121, when it is determined that the merchandise information is not stored in the RAM 51a (No in Step S118 or S121), the control unit 51 determines that the card is read in a state where the merchandise has not been selected, and executes error processing (Step S124). Then, the process returns to Step S111 and the control unit 51 goes into a standby state.

In Step S116, when it is determined that the card identification information is not input (No in Step S116), the control unit 51 determines whether or not the current time is a predetermined time (Step S125). If the current time is the predetermined time, the vending machine 5 transmits sales information stored in the vending machine 5 to the settlement server 6. That is, the settlement server 6 collects the sales information stored in the vending machine 5.

When it is determined that the current time is (or has passed) the predetermined time (Yes in Step S125), the control unit 51 reads all sales information stored in the sales information region 55b, and transmits the sales information to the settlement server 6 (Step S126). Then, the process returns to Step S111 and the control unit 51 goes into a standby state. When it is determined that the current time is prior to the predetermined time (No in Step S125), the process returns to Step S111 and the control unit 51 goes into a standby state.

According to the vending machine 5 of the first embodiment, merchandise information of the purchased merchandise through the vending machine 5, including the commercial information and the card identification information, which are associated with each other are transmitted to the electronic receipt management server 4. As a result, the electronic receipt management server 4 may be able to generate electronic receipt information based on the received information. For this reason, it is possible to provide information of a purchase transaction to a customer using the electronic receipt system, even though a paper receipt is not issued by the vending machine 5. As a result, a maintenance operation of filling receipt sheets in vending machines 5 may not be required. A function of managing a residual amount of a receipt sheet in each vending machine also may not be required.

In the vending machine 5 according to the first embodiment, when the SRID, as well as the card identification information, is transmitted to the electronic receipt management server 4, the electronic receipt management server 4 may be able to generate electronic receipt information based on the received SRID. For this reason, it is possible to provide information of a purchase transaction to a customer using the electronic receipt system even though a paper receipt is not issued by the vending machine 5. As a result, a maintenance operation of filling receipt sheets in vending machines 5 may not be required. A function of managing a residual amount of a receipt sheet in each vending machine also may not be required.

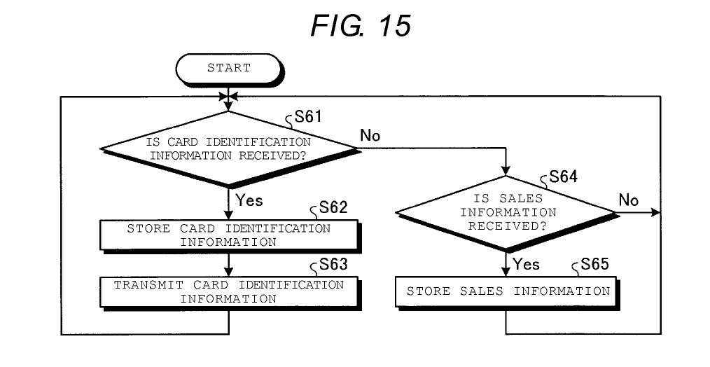

Next, a flow of control processing carried out by the control unit 61 of the settlement server 6, when the control unit executes the control program 63b will be described with reference to a flowchart illustrated in FIG. 15.

The control unit 61 of the settlement server 6 determines whether or not the card identification information transmitted from the vending machine 5 in Step S120 or S123 is received through the communication I/F 62 (Step S61). When it is determined that the card specification information is received (Yes in Step S61), the control unit 61 stores the received card identification information and the merchandise information received at the same time in the individual information region 63a of the storage unit 63 (Step S62). When the SRID is also received along with the card identification information, the control unit 61 also stores the SRID in the individual information region 63a. The control unit 61 transmits the merchandise information and the card identification information, which are stored in Step S62, to the electronic receipt management server 4 (Step S63), and then the process returns to Step S61.

When it is determined that the card identification information is not received (No in Step S61), the control unit 61 determines whether or not the sales information transmitted by the vending machine 5 in Step S126 is received (Step S64). When it is determined that the sales information is received (Yes in Step S64), the control unit 61 stores the received sales information in the sales information region 63c (Step S65). The control unit 61 performs sales management of merchandise sold through the vending machine 5, based on the sales information stored in the sales information region 63c.

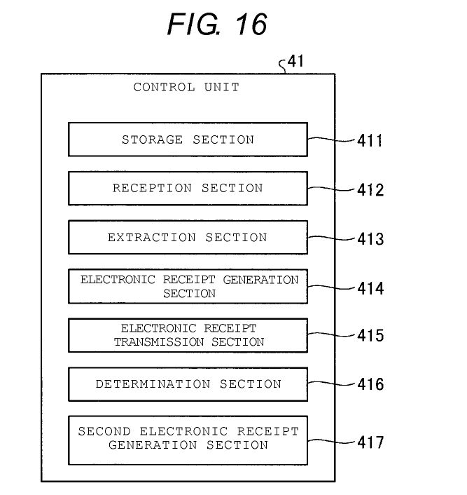

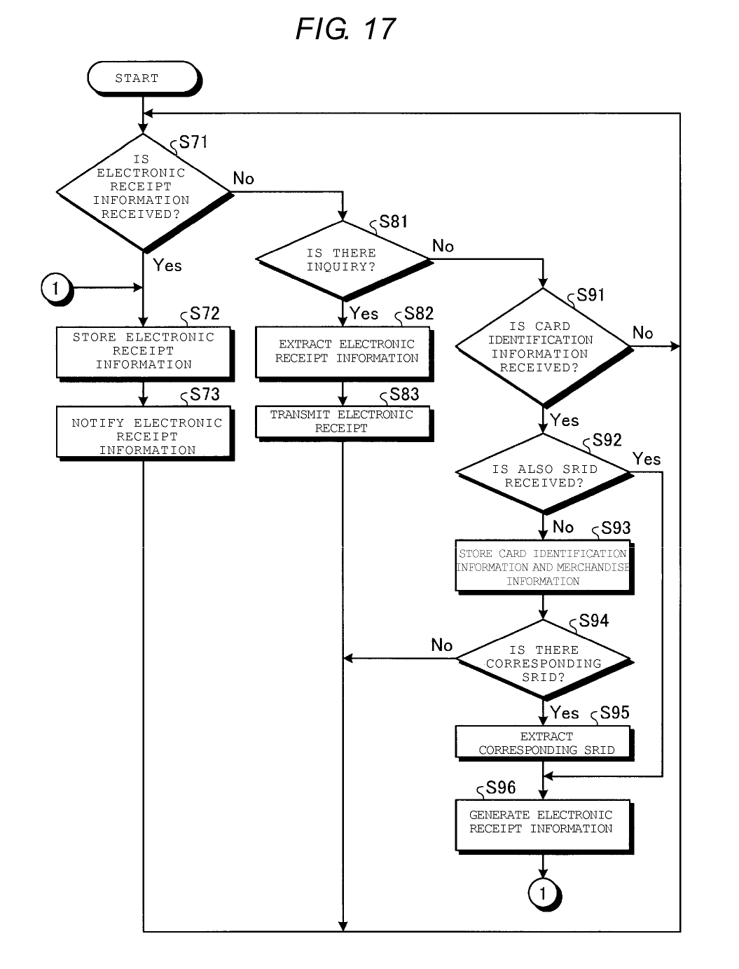

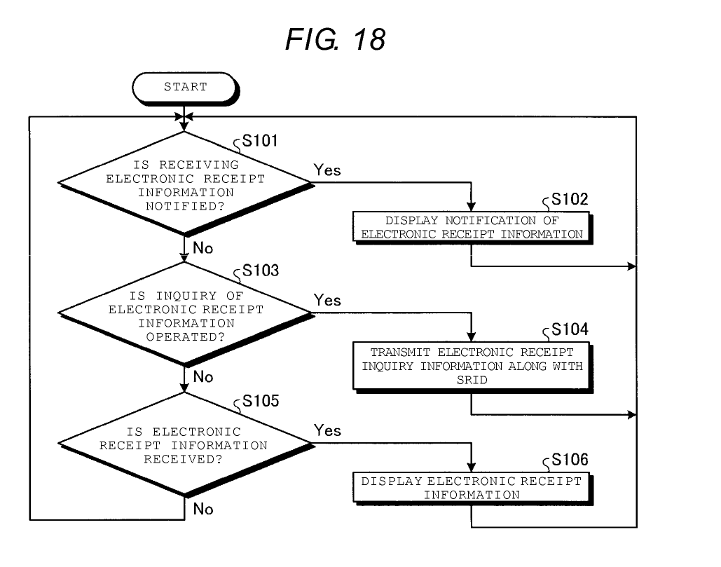

Next, control processing carried out by the control unit of the electronic receipt management server 4, when the control unit 41 executes the electronic receipt generation program 43b and the control program 43c, will be described with reference to a functional block diagram illustrated in FIG. 16 and a flowchart illustrated in FIG. 17.

As illustrated in FIG. 16, when the electronic receipt generation program 43b and the control program 43c executed by the electronic receipt management server 4, modules include a storage section 411, a reception section 412, an extraction section 413, an electronic receipt information generation section 414, an electronic receipt information transmission section 415, a determination section 416, and a second electronic receipt generation section 417 are generated. As actual hardware, the CPU of the control unit 41 reads the electronic receipt generation program 43b and the control program 43c from the storage unit 43, and executes the read electronic receipt generation program 43b and control program 43c. As a result, the storage section 411, the reception section 412, the extraction section 413, the electronic receipt information generation section 414, the electronic receipt information transmission section 415, the determination section 416, and the second electronic receipt generation section 417 are generated.

The storage section 411 has a function to store withdrawal destination information for specifying a withdrawal destination of a monetary value (e.g., card ID), and reception destination information for specifying a reception destination of electronic receipt information (e.g., member ID and SRID), which are correlated with each other.

The reception section 412 has a function to receive withdrawal destination and commercial information, from the vending machine 5, and the commercial information includes information on merchandise or a service which has been provided to a customer.

The extraction section 413 has a function to extract the reception destination which is correlated and stored, based on the received withdrawal destination.

The electronic receipt information generation section 414 has a function to generate electronic receipt information by digitalizing receipt information including the commercial information, based on the commercial information and the extracted reception destination.

The electronic receipt information transmission section 415 has a function to transmit the generated electronic receipt information to the reception destination.

The determination section 416 has a function to determine whether or not the reception section 412 has received the reception destination along with the commercial information.

The second electronic receipt generation section 417 has a function to generate electronic receipt information based on the received commercial information and reception destination, when the determination section 416 determines that the reception destination is received along with the commercial information.

FIG. 17 is a flowchart illustrating control processing carried out by the electronic receipt management server 4. In FIG. 17, the control unit 41 determines whether or not electronic receipt information is received from the electronic receipt server 3 (Step S71). When it is determined that the electronic receipt information is received (Yes in Step S71), the control unit 41 stores the received SRID in the SRID section 43a1 (Step S72). Also, the corresponding electronic receipt information is stored in the electronic receipt information section 43a3 (Step S72). Further, the control unit 41 stores an address of the portable terminal 7 from the membership information section 43d2 in the transmission address section 43a2 (Step S72). The address of the portable terminal 7 is stored in the customer management region 43d in correlation with an SRID. Then, the control unit 41 transmits to the portable terminal 7 having the address stored in the transmission address section 43a2, a notification that there is the electronic receipt information (Step S73). The process returns to Step S71 and the control unit 41 goes into a standby state.

When it is determined that the electronic receipt information is not received from the electronic receipt server 3 (No in Step S71), the control unit 41 determines whether or not there is an inquiry of electronic receipt information from the portable terminal 7 (Step S81). The inquiry of the electronic receipt information may be performed by a user operating the portable terminal 7 which receives the notification in Step S73 (details will be described below with reference to FIG. 18).

When it is determined that there is the inquiry of the electronic receipt information (Yes in Step S81), the control unit 41 extracts the electronic receipt information from the electronic receipt management region 43a (Step S82). The control unit 41 transmits the extracted electronic receipt information to the address included in the extracted electronic receipt information (Step S83). Then, the process returns to Step S71 and the control unit 41 goes into a standby state.

When it is determined that there is no inquiry of the electronic receipt information (No in Step S81), the control unit 41 determines whether or not the card identification information transmitted from the vending machine 5 in Step S120 or S123 is received (Step S91). When it is determined that the card identification information is received (Yes in Step S91), the control unit 41 determines whether or not the SRID transmitted from the vending machine 5 in Step S120 is received (Step S92).

When it is determined that the SRID has not been received (No in Step S92), the control unit 41 stores the received card identification information (information in an unstructured format) and the merchandise information (information in an unstructured format) received in Step S91 in the RAM of the control unit 41 (Step S93). The control unit 41 searches customer management region 43d based on the card identification information stored in the RAM.

If the stored card identification information is an electronic money card ID, the control unit 41 searches the electronic money ID section 43d3. If the stored card identification information is an IC card ID, the control unit 41 searches the IC card ID section 43d4. The control unit 41 determines whether or not there is an SRID corresponding to the received card identification information (Step S94).

When it is determined that there is the SRID (Yes in Step S94), the control unit 41 extracts the SRID stored in the SRID section 43d5 (Step S95). The control unit 41 generates electronic receipt information in the structured format based on the extracted SRID and the merchandise information stored in the RAM in Step S93 (Step S96). The control unit 41 executes processes subsequent to Step S72 with respect to the generated electronic receipt information. When it is determined that there is no SRID corresponding to the received card identification information (No in Step S94), the process returns to Step S71 and the control unit 41 goes into a standby state.

In Step S92, when it is determined that the SRID is received from the vending machine 5 (Yes in Step S92), the control unit 41 executes processes subsequent to Step S96. In Step S96, the electronic receipt information in the structured format is generated based on the received SRID and merchandise information. In Step S91, when it is determined that the card identification information is not received (No in Step S91), the process returns to Step S71 and the control unit 41 goes into a standby state.

The electronic receipt management server 4 according to the first embodiment stores the card identification information and the SRID to correspond to each other, extracts the SRID corresponding to the card identification information transmitted from the vending machine 5, and generates electronic receipt information based on the extracted SRID and the received merchandise information. As a result, it is possible to provide information of a purchase transaction to a customer by a form of an electronic receipt even though a paper receipt is not issued by the vending machine 5. For this reason, a maintenance operation to refill receipt sheets in vending machines 5 may not be required. A function of managing a residual amount of a receipt sheet in each vending machine 5 also may not be required.

Next, a flow of electronic receipt reception processing carried out when the control unit 71 of the portable terminal executes the electronic receipt correspondence program 75a and a flow of electronic receipt displaying processing carried out when the control unit 71 executes the electronic receipt displaying program 75b will be described with reference to FIG. 18.

As illustrated in FIG. 18, the control unit 71 determines whether or not a notification is received from the electronic receipt management server 4 (Step S101). The notification indicates that electronic receipt information has been received from the electronic receipt server 3. When it is determined that the notification is received (Yes in Step S101), the control unit 71 displays the notification on the display unit 73 (Step S102). This notification is a message “an electronic receipt of a customer is available”, and the like, for example.

When it is determined that the notification of receiving the electronic receipt information is not received (No in Step S101), the control unit 71 determines whether or not an inquiry of the electronic receipt information is requested (Step S103). An operator of the portable terminal 7 who finds the notification operates the operation unit 72 in order to transmit the inquiry of the electronic receipt information. When it is determined that the inquiry is requested (Yes in Step S103), the control unit 71 transmits an inquiry of electronic receipts and an SRID for specifying the portable terminal 7, which is stored in the SRID storage region 75c, to the electronic receipt management server 4 (Step S104). The electronic receipt management server 4 which receives the inquiry executes processes of Steps S81 to S83 in FIG. 17 and transmits the electronic receipt information to the portable terminal 7.

When it is determined that the inquiry of the electronic receipt information is not requested (No in Step S103), the control unit 71 determines whether or not the electronic receipt information is received from the electronic receipt management server 4 (Step S105). When it is determined that the electronic receipt information is received (Yes in Step S105), the control unit 71 displays the received electronic receipt information on the display unit 73 (Step S106). When only the electronic receipt information is received, the control unit 71 operates to display the received electronic receipt information.

As described above, in the first embodiment, the card identification information which is input in the vending machine 5, and the merchandise information of the purchased merchandise are transmitted to the electronic receipt management server 4. The vending machine 5 also transmits the SRID to the electronic receipt management server 4. The electronic receipt management server 4 generates the electronic receipt information based on the received card identification information or SRID.

In the first embodiment, the electronic receipt information may be generated by the settlement server 6, instead of the electronic receipt management server 4. In this case, the settlement server 6 serves as an information processing apparatus.

### Second Embodiment

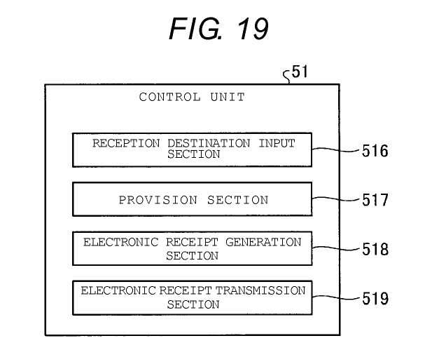

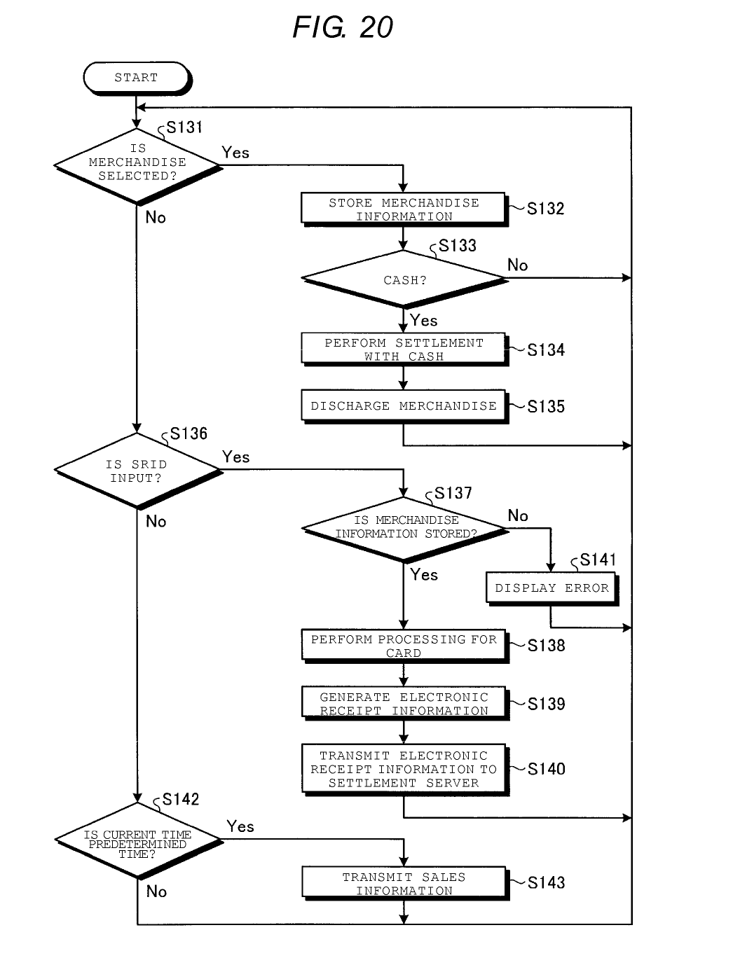

Next, a second embodiment will be described. The second embodiment has a configuration of the vending machine 5 different from the first embodiment. Control processing carried out when the control unit 51 of the vending machine 5 according to the second embodiment executes the control program 55a will be described with reference to FIGS. 19 and 20.

As illustrated in FIG. 19, when the control program 55a executed by the vending machine 5, modules including a reception destination input section 516, a provision section 517, an electronic receipt generation section 518, and an electronic receipt transmission section 519. As actual hardware, the CPU of the control unit 51 reads and executes the control program 55a from the storage unit 55. As a result, the reception destination input section 516, the provision section 517, the electronic receipt generation section 518, and the electronic receipt transmission section 519 are generated.

The reception destination input section 516 has a function to input reception destination information for specifying a reception destination of electronic receipt information, from a storage medium.

The provision section 517 has a function to provide merchandise or a service for a customer in accordance with an operation.

The electronic receipt generation section 518 has a function to generate electronic receipt information by digitalizing the input reception destination information and commercial information including information on the provided merchandise or service.

The electronic receipt transmission section 519 has a function to transmit the generated electronic receipt information to an external apparatus which is associated with the reception destination information.

FIG. 20 is a flowchart illustrating control processing of the vending machine 5 according to the second embodiment. In FIG. 20, the same details and components as those in FIG. 14 cite the reference signs in FIG. 14 and descriptions thereof will be simplified.

Steps S131 to S135 in FIG. 20 are the same as Steps S111 to S115 in FIG. 14, and descriptions thereof will be omitted. In Step S131, when it is determined that merchandise is not selected in the vending machine 5 (No in Step S131), the control unit 51 determines whether or not an SRID is input (Step S136). In the second embodiment, the card identification information is not input, but an SRID stored in an electronic money card, an IC card, or the portable terminal 7 is input. The SRID is read by the near field wireless communication unit 57.

When it is determined that the SRID is input (Yes in Step S136), the control unit 51 executes Steps S137 and S138 (the same as Steps S118 and S119), and then generates electronic receipt information in the structured format based on the input SRID (information in the unstructured format) and the merchandise information (information in the unstructured format) which is stored in the RAM 51a (Step S139). The control unit 51 transmits the generated electronic receipt information to the settlement server 6 (Step S140). Then, the process returns to Step S131 and the control unit 51 goes into a standby state. The electronic receipt information transmitted to the settlement server 6 is further transmitted from the settlement server 6 to the electronic receipt management server 4.

In Step S137, when it is determined that the merchandise information is not stored (No in Step S137), the control unit 51 executes error processing which is similar to Step S124 (Step S141).

In Step S136, when it is determined that the SRID is not input (No in Step S136), the control unit 51 executes processes of Steps S142 and S143 (similar to processes of Steps S125 and S126). Then, the process returns to Step S131, and the control unit 51 goes into a standby state.

The vending machine 5 according to the second embodiment generates electronic receipt information when the SRID is input, and transmits the generated electronic receipt information to the electronic receipt management server 4 through the settlement server 6. As the electronic receipt management server 4 is not required to generate the electronic receipt information, it is possible to use the existing electronic receipt management server 4 as it is.

In the second embodiment, card identification information may be input to the vending machine 5, and the vending machine 5 may extract an SRID from the input card identification information and generate electronic receipt information based on the extracted SRID.

In the above-described embodiments, the vending machine 5 is used as an automatic charge collection apparatus. However, for example, a ticket machine which issues a ticket of an electric railcar or a ticket of a bus, an automatic ticket gate which is used when a person enters into a station or the like may be used as the automatic charge collection apparatus. In a case of the ticket machine, the commercial information may include a ticket type or purchased amount. In a case of the automatic ticket gate, the commercial information may include a fare or a fare zone.

In the above embodiments, an example of using a card as a medium is described, but media (for example, portable terminal) other than the card may be used.

In the above embodiments, an electronic money card ID or an IC card ID is described as an example of card identification information. However, for example, a credit card ID for specifying a credit card may be used. When a payment medium, such as a credit card, is used, payment information of the payment medium is transmitted to a payment server for confirmation of the purchase transaction in step S119, and the merchandise information is transmitted to the settlement server 6, upon receiving the confirmation from the payment server.

The programs which are executed in the vending machine 5 and the electronic receipt management server 4 according to the embodiments may be files of an installable format or an executable format. The programs may be stored and provided in a computer readable recording medium such as a CD-ROM, a flexible disk (FD), a CD-R, and a digital versatile disk (DVD).

Alternatively, the programs executed in the vending machine 5 and the electronic receipt management server 4 according to the embodiment may be stored in a computer connected to a network such as the Internet, and be provided by downloading the programs through the network. The programs executed in the vending machine 5 and the electronic receipt management server 4 according to the embodiment may be provided through a network such as the Internet or be distributed.

The programs executed in the vending machine 5 and the electronic receipt management server 4 according to the embodiment may be stored in a ROM and the like in advance, and may be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A vending machine comprising:
a first input device through which a user selects a product or service to be purchased;
a second input device by which the user submits payment information to a first server;
a dispensing unit configured to dispense a product or service that the user selects through the first input device upon receiving confirmation of payment from the first server; and
a communication unit configured to transmit electronic data describing the product or service purchased and the payment information to a second server.

2. The vending machine according to claim 1, wherein
the payment information is recorded in a payment medium carried by the user, and the second input device is configured to read the payment information from the payment medium.

3. The vending machine according to claim 1, wherein
the payment information is magnetically recorded in the payment medium.

4. The vending machine according to claim 1, wherein
the payment information is electronically recorded in the payment medium.

5. The vending machine according to claim 4, wherein
the payment medium is a mobile computing device carried by the user.

6. The vending machine according to claim 1, wherein
the electronic data is unstructured data.

7. The vending machine according to claim 1, further comprising:
a control unit configured to convert unstructured electronic data describing the product or service purchased into structured electronic data, wherein
the structured electronic data is transmitted by the communication unit.

8. The vending machine according to claim 1, wherein
at least one of the first input device or the second input device is configured to receive user identification information of the user, and
the communication unit transmits the user identification information, together with the electronic data and the payment information.

9. The vending machine according to claim 1, wherein
the dispensing unit stores one or more products to be dispensed.

10. The vending machine according to claim 1, wherein
the dispensing unit includes a printer configured to print image on a medium, and the medium having the printed image is dispensed as the product.

11. A vending machine comprising:
an input device through which a user selects a product or service to be purchased;
a read/write device configured to read payment information and a balance from a payment medium carried by the user and write a value calculated by deducting a value of the product or service selected through the input device from the balance, in the payment medium;
a dispensing unit configured to dispense a product or service that the user selects through the first input device upon confirmation of payment; and
a communication unit configured to transmit electronic data describing the product or service purchased and the payment information to a server.

12. The vending machine according to claim 11, wherein
the read/write device performs the reading and writing using wireless communication.

13. The vending machine according to claim 11, wherein
the payment information is magnetically recorded in the payment medium.

14. The vending machine according to claim 11, wherein
the payment information is electronically recorded in the payment medium.

15. The vending machine according to claim 14, wherein
the payment medium is a mobile computing device carried by the user.

16. The vending machine according to claim 11, wherein
the electronic data is unstructured data.

17. The vending machine according to claim 11, further comprising:
a control unit configured to convert unstructured electronic data describing the product or service purchased into structured electronic data, wherein
the structured electronic data is transmitted by the communication unit.

18. The vending machine according to claim 11, wherein
at least one of the first input device or the second input device is configured to receive user identification information of the user, and
the communication unit transmits the user identification information, together with the electronic data and the payment information.

19. The vending machine according to claim 11, wherein
the dispensing unit stores one or more products to be dispensed.

20. The vending machine according to claim 11, wherein
the dispensing unit includes a printer configured to print image on a medium, and the medium having the printed image is dispensed as the product.
